(19) United States
(12) Patent Application Publication
(10) Pub. No.: US 2025/0381859 A1
(43) Pub. Date: Dec. 18, 2025

(54) METHOD AND SYSTEM FOR OPTIMIZING WIRELESS POWER TRANSMISSION TO AN ELECTRIC VEHICLE ON THE ROAD VIA ADAPTIVE FREQUENCY

(71) Applicant: Electreon Wireless Ltd., Beit Yanai (IL)

(72) Inventors: Hanan RUMBAK, Mazkeret Batya (IL); Oren EZER, Tel Aviv (IL)

(73) Assignee: Electreon Wireless Ltd., Beit Yanai (IL)

(21) Appl. No.: 18/878,134

(22) PCT Filed: Feb. 20, 2023
(86) PCT No.: PCT/IL2023/050177

§ 371 Date: Dec. 23, 2024

(51) Int. Cl. B60L 53/126; B60L 53/122; B60L 53/30; B60L 53/65; B60L 53/66; H02J 50/12; H02J 50/90

(52) U.S. Cl. CPC B60L 53/126; B60L 53/122; B60L 53/305; B60L 53/32; B60L 53/65; B60L 53/66; H02J 50/12; H02J 50/90; B60L 2210/20

(57) ABSTRACT

A system for controlling a frequency of a wireless power signal transmitted from a plurality of power transmitting segments located along a road. The system may include: a plurality of base stations located along the road, wherein each base station may include, for each one of the segments: a power converter configured to convert an alternating current at a power distribution frequency; a phase detection circuitry, configured to detect a voltage-to-current phase of the powering signal on one of the segments that has been powered; and a frequency control circuitry, configured to control the power transmission frequency of the powering signal on the segment that has been powered, based on the voltage-to-current phase, so as to reduce an absolute value of a voltage-to-current phase to a predefined level as long as the power receiving coils of the electric vehicle are passing over the power transmitting segments that has been powered.

### FIELD OF THE INVENTION

The present invention relates generally to wireless power transmission in electric vehicles.

### BACKGROUND OF THE INVENTION

Prior to setting forth the background of the invention, the following term definitions are provided:

The term ‘electric vehicle’ refers generally to a vehicle powered solely, or in part, by electrical energy stored (e.g., chemically) in a battery, or the like. In the present context, an ‘electric vehicle’ moreover has provision for receiving (e.g., at coils disposed on the underside of the vehicle) a wirelessly induced electromotive force (i.e., voltage) that may be stored, or otherwise utilized to recharge the battery. For an electromagnetically induced voltage to occur, the vehicle (i.e., the ‘conductor’) may be moving relative to a magnetic field which is, for example, projected about the road upon which the vehicle is travelling. Alternatively, the magnetic field may be periodically varied (e.g., through use of alternating current) thereby inducing a voltage at the vehicle.

The term ‘road section’ refers generally to a portion of, for example, a highway or motorway which has been modified to comprise a medium for wirelessly transmitting power (i.e., a ‘power transmitter’). This may mean that the road comprises a plurality of coils embedded beneath the surface of the road section which are operable to emit a magnetic field. In typical arrangements, the medium (coils) may be connected to an alternating current source, e.g. an electrical grid, and may generate a varying magnetic field, thereby inducing a voltage in any proximate conductor. One possible approach to powering on-road electric vehicles via wireless power transfer is disclosed in EP 3089886 B1 and is incorporated herein by reference.

FIG. 1 is a block diagram illustrating a prior art wireless power transmission system 100. Wireless power transmission system 100 may include a plurality of electric vehicles 150 comprising an attached power receiver, for example, to an underside of the vehicle. The plurality of electric vehicles may further travel upon a road section 101 having one or more power transmitters 120 disposed, for example, underneath the surface of the road section and fed by power converter 122 connected to an electrical grid. In some embodiments, each power receiver and power transmitter may comprise one or more wound or looped coils coupled, for example, to an alternating current source. In some arrangements, these coils may be operable to emit a static or varying magnetic field into a vicinity about the coils, for example around the road section or portions thereof. As each electric vehicle travels along road section 101, a magnetic field formed by power transmitters in road section 101 induces a voltage in each power receiver and is stored and/or converted by the electric vehicle into, for example, chemical energy in a battery. In alternative embodiments, the induced energy may be immediately used by an engine of the electric vehicle without storage.

As the electric vehicle passes over the transmitting coils the alignment of the receiving coils with respect to the transmitting coils changes. This may decrease a resonance frequency of the receiving array relative to an operating resonance frequency of the transmitter array, which may result in non-optimal transmission of power.

### SUMMARY OF THE PRESENT INVENTION

The present invention provides a system for controlling the frequency of powering over the air transmitter for electrical vehicles moving over a road. The transmitter side has a control unit that monitors the voltage to current phase and deduces the displacement between receiver-side coils and the corresponding transmitter-side coils. The frequency is then amended dynamically based on this displacement so as to ensure resonance or near-resonance operation.

According to some embodiments of the present invention, there is provided a system for controlling a frequency of a wireless power signal transmitted from a plurality of power transmitting segments located along a road and under a surface thereof, each power transmitting segment comprising two or more transmitting coils, to power receiving coils located on electric vehicles moving along said road, the system comprising: a plurality of base stations located along said road, each base station is configured to selectively power a plurality of the segments located in series separate wiring, wherein each base station comprising, for each one of the segments powered by said base station: a power converter for each of the segments powered by the base station configured to convert an alternating current coming from a power grid at a power distribution frequency, and output a powering signal at a power transmission frequency range; a phase detection circuitry, configured to detect a voltage-to-current phase of the powering signal on one of the segments that has been powered; and a frequency control circuitry, configured to control the power transmission frequency of the powering signal on the segment that has been powered, based on the voltage-to-current phase, so as to reduce an absolute value of a voltage-to-current phase to a predefined level as long as the power receiving coils of the electric vehicle are passing over said one of the one of the power transmitting segments that has been powered.

These and other advantages of the present invention are set forth in detail in the following description.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a block diagram showing wireless power transmission system for an electric vehicle on a road in accordance with the prior art;

FIGS. 2A and 2B are diagrams showing an arrangement of receiving coils in transmitting and a receiving array in accordance with some embodiments of the present invention;

FIG. 3 is a diagram showing the system in accordance in embodiments of the present invention in accordance with some embodiments of the present invention;

FIG. 4A and 4B are diagrams showing the graphs of how the power may be varied for various frequency bands of the generator should be changed based on the displacement bands of the receiver-side coils vis a vis the corresponding transmitter-side coils in accordance with some embodiments of the present invention; and

FIG. 5 is a flowchart illustrating a method in accordance with some embodiments of the present invention.

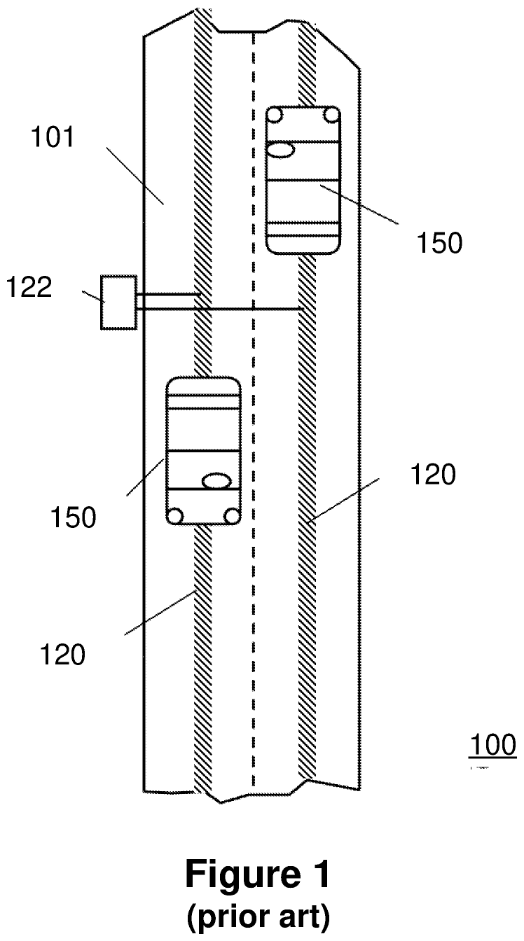

### DETAILED DESCRIPTION OF THE INVENTION

With specific reference now to the drawings in detail, it is stressed that the particulars shown are for the purpose of example and solely for discussing the preferred embodiments of the present invention and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

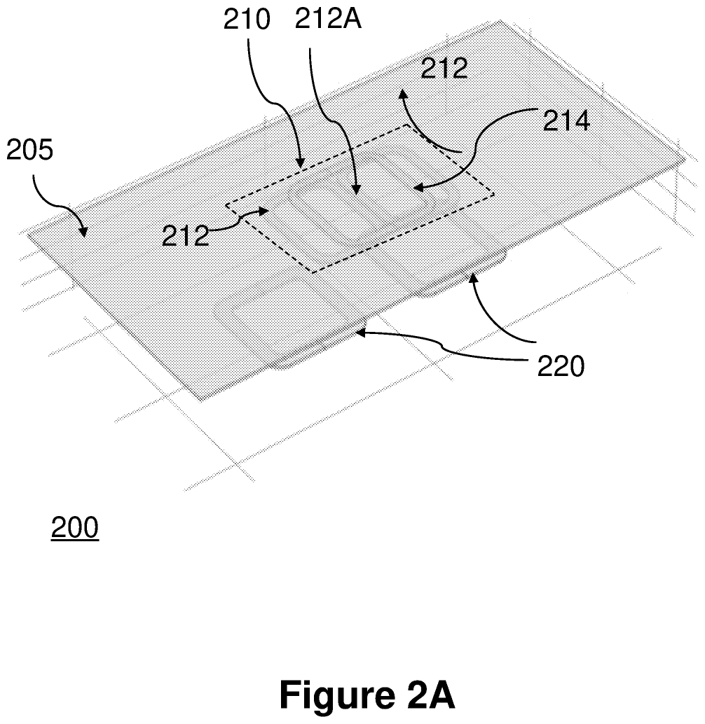

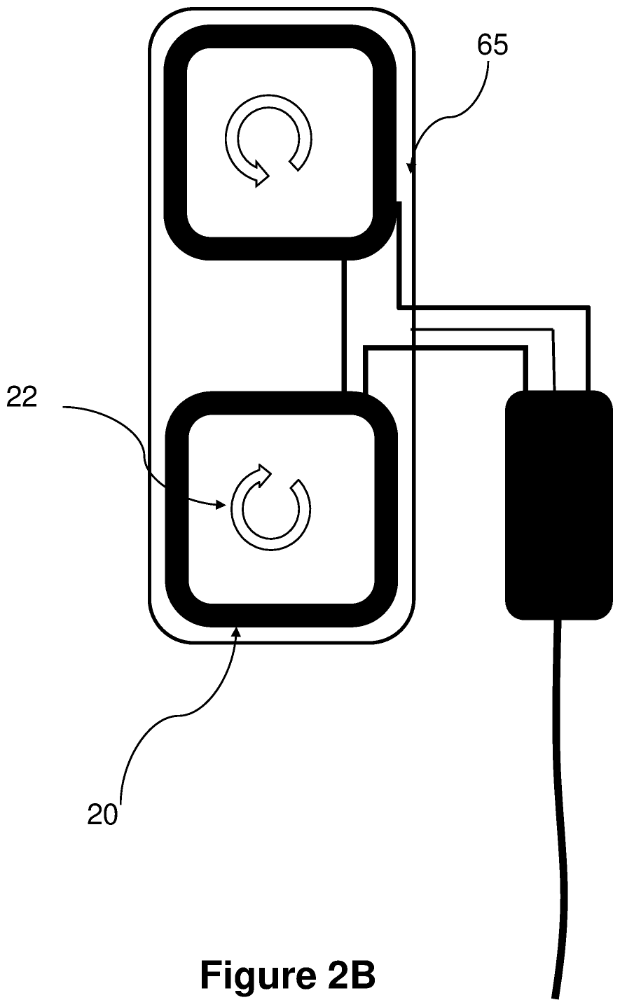

FIGS. 2A and 2B show an exemplary arrangement of receiver coils 210 in a receiver array 200. Measurements shown demonstrate exemplary dimensions only and are not intended to be limiting. Receiving coils 210 may be disposed on the underside of an electric vehicle (not shown), parallel to a road having a road section disposed with transmitting coils 220. Receiving coils 210 may receive power transmitted by transmitting coils 220. Lower receiving coils 212 may be placed edge to edge thereby defining a joining line 212a in the shared plane of the road section and of the coils. Such joined coils 212 may be referred to as a “figure-of-8” coil. An upper receiving coil 214 may be placed over top of the lower receiving coils 212. Upper receiving coil 214 may have dimensions different than those of lower receiving coils 212 and upper receiving coil 214 may have dimensions identical to those of transmitting coils 220. Upper receiving coil 214 may be placed so as to have its geometric center 214a lying on the joining line 212a of the lower receiving coils 212. The geometric center of an object is defined as the mean position of all the points of the object in all of the coordinate directions. The configuration of upper and lower receiving coils 210 may be repeated periodically along the underside of the electric vehicle. The receiving coils 210 may be circular or rectangular or variations thereof, e.g. oval or oblong in shape. Receiver array 200 may include a ferrite plate 205. When deployed ferrite plate 205 acts to shape and contain magnetic flux so as to prevent any adverse effects arising from transmission of magnetic flux through to the interior of the electric vehicle.

Such a configuration of upper and lower receiving coils 210 has been found to provide optimal power transference at fixed frequency operation of transmitting coils 220 at fixed alignment. However, relative motion between transmitting coils 220 and receiving coils 210 due to motion of the electric vehicle reduces the efficiency of power transference due to change in coupling coefficient. One solution may be to power the transmitter coils 220 at average power. This however is not efficient.

It may therefore be useful to dynamically adjust the power transference characteristics of the transmitter coils in response to information of where the receiving coils are relative to the transmitter coils. Because power transference happens over road sections of only 2 m for example, the positioning of the coils relative to one another happens over cm scales and so systems for precision location with errors on the scale of centimeters are not suitable.

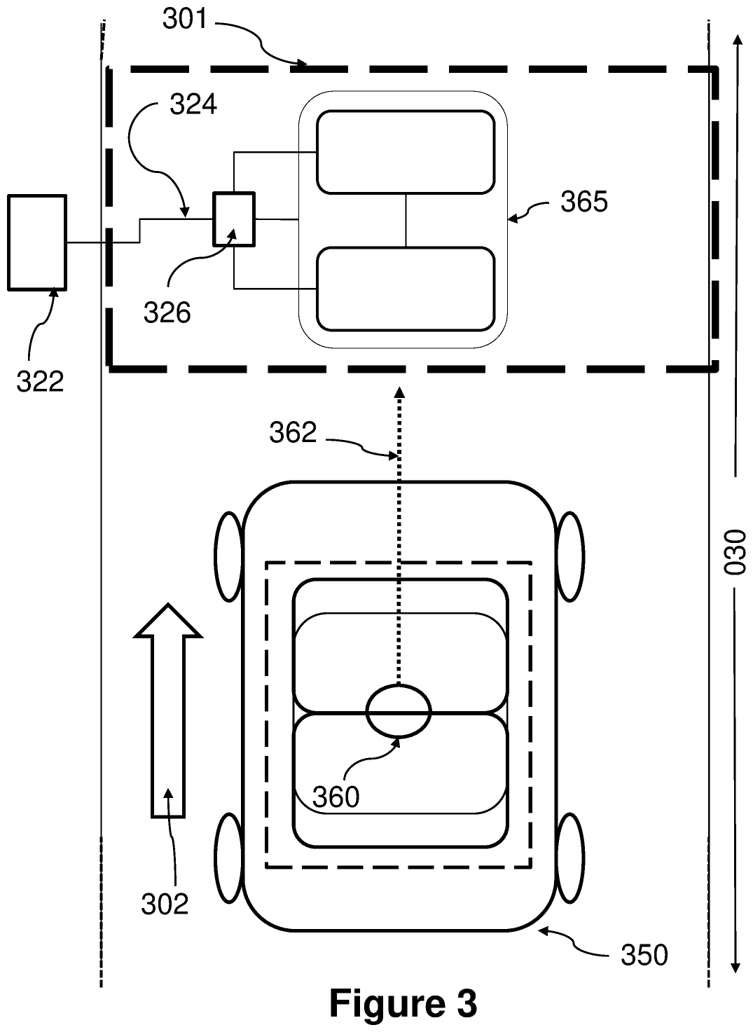

FIG. 3 shows a wireless power system 300 for an electric vehicle 350 on a road 030. Road 030 may have a road section 301 disposed with transmitter coils 320 (potentially under the surface of road 030). Road section 301 may be fed by power converter 322 which may itself be fed by an electrical grid (not shown). Power converter 322 may be connected to a base station (not shown). The base station may be able to access a database of electric vehicles subscribed to a power payment plan. Power converter 322 may be connected to a capacitor pack 326 via an access cable 324. Access cable 324 may carry different types of electrical signal, e.g. access cable 324 may comprise at least one communication channel and at least one power delivery channel. Electric vehicle 350 may travel on road 030 in a direction 302 towards road section 301. Electric vehicle 350 may have a power receiver array comprising a plurality of receiving coils 310 which may be disposed on the underside of electric vehicle 350.

Electric vehicle 350 may also have a communication loop 360. Communication loop 360 may transmit a communication signal 362. Communication signal 362 may be modulated with an identity (ID) code so as to be uniquely associated with electric vehicle 350. For example, an ID code may comprise but is not limited to: a vehicle registration number; a driver registration number; or a subscription number. Communication signal 362 may be transmitted with a higher frequency than a frequency of power to be transmitted by transmitter coils 320.

Communication signal 362 may be received by communication antenna loop 365 associated with road section 301. Communication antenna loop 365 may be connected to capacitor pack 326. Communication antenna loop 365 may be configured to control the transmission of power of transmitter coils 320. Communication antenna loop 365 may be configured to only initialize power transmission of transmitter coils 320 in response to a communication signal 362 that identifies electric vehicle 350 as being associated with a valid subscription to a power payment plan. The determination of the validity of communication signal 362 may be carried out at the base station and relayed back to road section 301.

In operation, the power of the convertor 322 of each powered segment 365 is being monitored and being changed in an adaptive manner ensure resonance or near-resonance conditions. This is achieved by the power transmitting side only without any control or measurement units on the power receiving side, i.e. without a need to monito anything on the electric vehicle.

According to some embodiments of the present invention, the resonant frequency is set as the frequency at which the current-to-voltage phase of the convertor 322 equals zero.

According to some embodiments of the present invention, the resonant frequency of the transmitter segment is measured without any power receiver (e.g., electric vehicle) above it and defined as zero load resonance (ZLR).

When an electric car moves along the road, its communication transmitter continuously transmits a communication signal requesting power from the road segments it is about to move over. The power requesting signal the communication signal frequency includes an ID code modulated thereon so the segment and the base statin can recognize it and electrify the power transmitting side accordingly. As soon as the power receiving unit of an electric vehicle approaches a given power transmitting segment, a dedicated communication receiver on the power transmitting segment receives and detects the identification code and activates the converter of the transmitter segment on a minimal power level (so it can measure current, voltage, phase and the like).

From this point onwards, right after the transmitter recognizes the communication it starts powering the primary coils with minimum current. Once the receiver unit of the electrical vehicle passes over the transmitter segment, the common resonance frequency decreases, and as the coupling between them increases, the resonance frequency decreases.

In order to address the drop in the resonance frequency, according to some embodiments of the present invention, the monitoring the converter associated with of the specific transmitter segment is carried out so as to detect the phase difference between the voltage and the current of the transmitter segment. In response to detection of such phase, the convertor frequency is modified that until the phase is again zero.

According to some embodiments of the present invention, in order to decide the operating frequency of the converter, a look up table or a similar mechanism can be used to map a measure voltage-to-current phase and a change in the frequency that is needed.

Similar look up table may be used to determine the displacement of the power receiver unit vis a vis the power transmitting segment, and as such, the exact location of an electric vehicle relative to the road.

According to some embodiments of the present invention, there is provided a system for controlling a frequency of a wireless power signal transmitted from power plurality of power transmitting segments located along a road and under a surface thereof, each power transmitting segment comprising two or more transmitting coils, to power receiving coils located on electric vehicles moving along said road, the system comprising: a plurality of base stations located along said road, each base station is configured to selectively power a plurality of the segments located in series separate wiring, wherein each base station comprising, for each one of the segments powered by said base station: a power converter for each of the segments powered by the base station configured to convert an alternating current coming from a power grid at a power distribution frequency, and output a powering signal at a power transmission frequency range; a phase detection circuitry, configured to detect a voltage-to-current phase of the powering signal on one of the segments that has been powered; and a frequency control circuitry, configured to control the power transmission frequency of the powering signal on the segment that has been powered, based on the voltage-to-current phase, so as to reduce an absolute value of a voltage-to-current phase to a predefined level as long as the power receiving coils of the electric vehicle are passing over said one of the one of the power transmitting segments that has been powered.

According to some embodiments of the present invention, the power transmitting segments comprise a communication receiver configured to receive from an authorized electrical vehicle a power request signal, and wherein the converter is switched on only in a case that the power request signal is authorized.

According to some embodiments of the present invention, the power transmission frequency range is from 80 KHz to 90 Khz.

According to some embodiments of the present invention, modifying the frequency of the power transmission signal may be based on the voltage-to-current phase ensures operating at resonance or near-resonance between the power transmitting coils and the power receiving coils throughout the passing of the power receiving coils over the one of the power transmitting segments.

According to some embodiments of the present invention, the frequency control circuitry may be further configured to increase a power level of the powering signal based on the voltage-to-current phase.

According to some embodiments of the present invention, the frequency control circuitry may be configured to modify the frequency of the power transmitting signal using switching circuitries.

According to some embodiments of the present invention, the frequency control circuitry may be further configured to increase a power level of the powering signal based on the voltage-to-current phase by controlling a duty cycle of said switching circuitry for various bands.

According to some embodiments of the present invention, wherein the voltage-to-current phase represents one of a plurality of bands, each representing a level of overlap between the power transmitting coils of the one of a plurality of the power transmitting segments and the power receiving coils of the electric vehicle as it passes over said one of a plurality of the power transmitting segments.

According to some embodiments of the present invention, the base stations may be configured to calculate a displacement of the receiving coils of a vehicle relative to the power transmitting coils of the one of the plurality of the power transmitting segments, based on the voltage-to-current phase.

According to some embodiments of the present invention, the voltage-to-current phase represents one of a plurality of bands, each representing a level of overlap between the power transmitting coils of the one of a plurality of the power transmitting segments and the power receiving coils of the electric vehicle as it passes over said one of a plurality of the power transmitting segments.

According to some embodiments of the present invention, the power at zero load it is guaranteed to be off, in order to ensure no powering of the transmitter segment occur when there is no vehicle above it. This is done for safety and power efficiency.

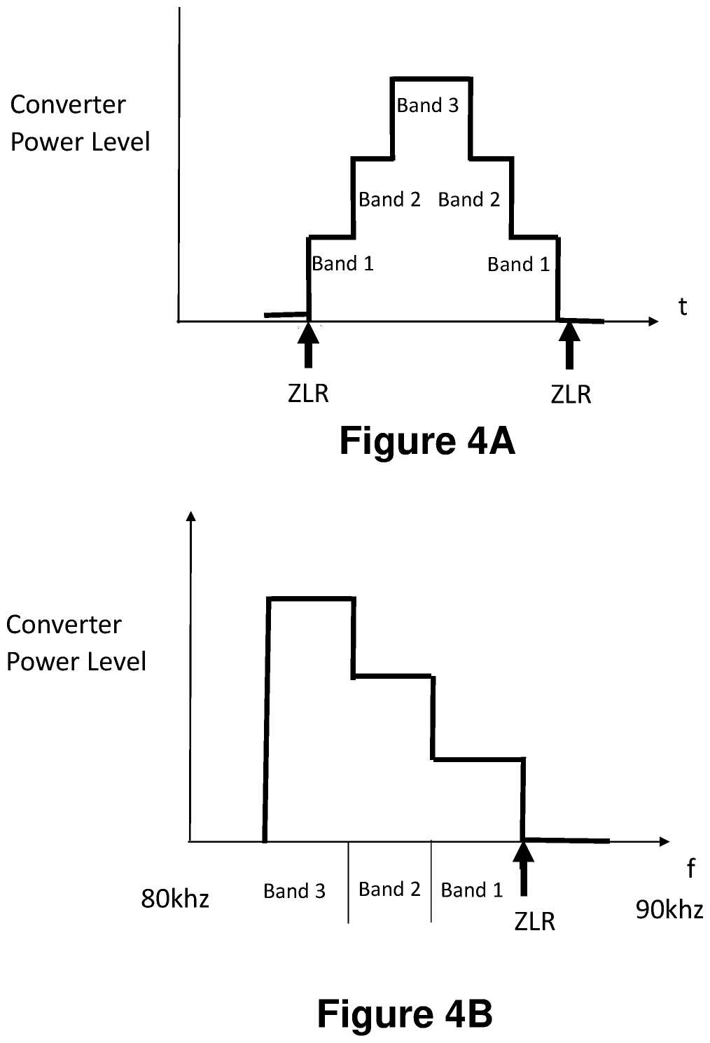

FIG. 4A and 4B are diagrams showing the graphs of how the power may be varied for various frequency bands of the generator should be changed based on the displacement bands of the receiver-side coils vis a vis the corresponding transmitter-side coils in accordance with some embodiments of the present invention.

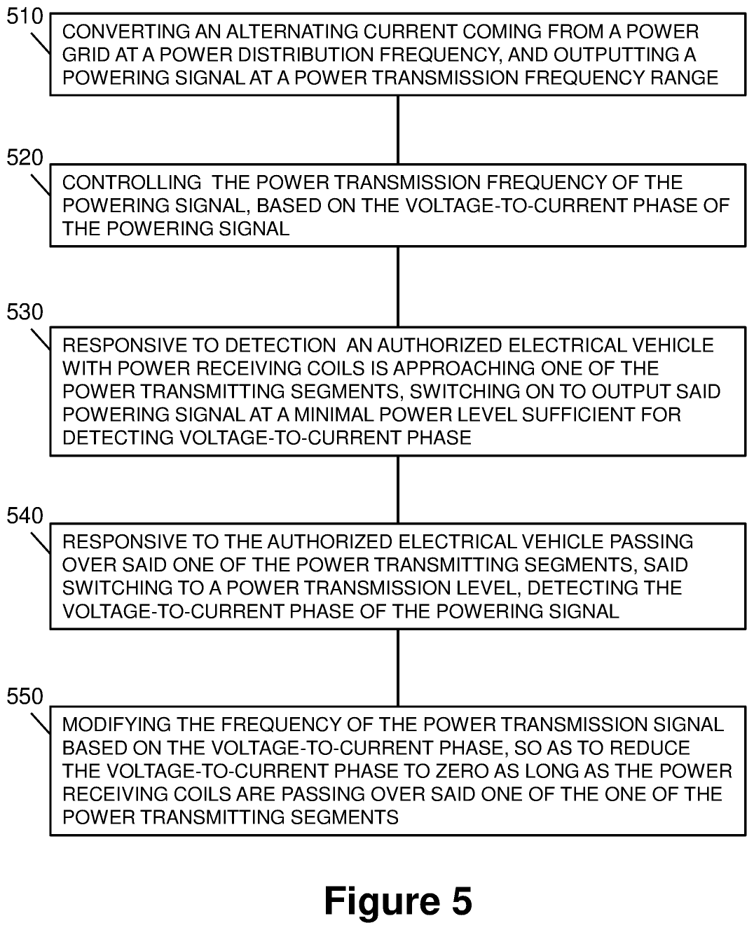

FIG. 5 is a flowchart illustrating a method in accordance with some embodiments of the present invention. The method includes the following steps: converting an alternating current coming from a power grid at a power distribution frequency, and outputting a powering signal at a power transmission frequency range 510; controlling the power transmission frequency of the powering signal, based on the voltage-to-current phase of the powering signal 520; responsive to detection an authorized electrical vehicle with power receiving coils is approaching one of the power transmitting segments, switching on to output said powering signal at a minimal power level sufficient for detecting voltage-to-current phase 530; responsive to the authorized electrical vehicle passing over said one of the power transmitting segments, said switching to a power transmission level, detecting the voltage-to-current phase of the powering signal 540; and modifying the frequency of the power transmission signal based on the voltage-to-current phase, so as to reduce the voltage-to-current phase to zero as long as the power receiving coils are passing over said one of the one of the power transmitting segments 550.

The aforementioned flowchart and diagrams illustrate the architecture, functionality, and operation of possible implementations of systems, methods, and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit”, “module” or “system”.

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention. It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A system for controlling a frequency of a wireless power signal transmitted from a plurality of power transmitting segments located along a road and under a surface thereof, each power transmitting segment comprising two or more transmitting coils, to power receiving coils located on electric vehicles moving along said road, the system comprising:
a plurality of base stations located along said road, each base station is configured to selectively power a plurality of the segments located in series separate wiring, wherein each base station comprising, for each one of the segments powered by said base station:
a power converter for each one of the segments powered by the base station configured to convert an alternating current coming from a power grid at a power distribution frequency, and output a powering signal at a power transmission frequency range;
a phase detection circuitry, configured to detect a voltage-to-current phase of the powering signal on one of the segments that has been powered; and
a frequency control circuitry, configured to control the power transmission frequency of the powering signal on the segment that has been powered, based on the voltage-to-current phase, so as to reduce an absolute value of a voltage-to-current phase to a predefined level as long as the power receiving coils of the electric vehicle are passing over said one of the one of the power transmitting segments that has been powered.

2. The system according to claim 1, wherein the power transmitting segments comprise a communication receiver configured to receive from an authorized electrical vehicle a power request signal, and wherein the converter is switched on only in a case that the power request signal is authorized.

3. The system according to claim 1, wherein the power transmission frequency range is from 80 KHz to 90 Khz.

4. The system according to claim 1, wherein modifying the frequency of the power transmission signal based on the voltage-to-current phase ensures operating at resonance or near-resonance between the power transmitting coils and the power receiving coils throughout the passing of the power receiving coils over the one of the power transmitting segments.

5. The system according to claim 3, wherein the frequency control circuitry is further configured to increase a power level of the powering signal based on the voltage-to-current phase.

6. The system according to claim 1, wherein the frequency control circuitry is configured to modify the frequency of the power transmitting signal using switching circuitries.

7. The system according to claim 6, wherein the frequency control circuitry is further configured to increase a power level of the powering signal based on the voltage-to-current phase by controlling a duty cycle of said switching circuitry for various bands.

8. The system according to claim 1, wherein the voltage-to-current phase represents one of a plurality of bands, each representing a level of overlap between the power transmitting coils of the one of a plurality of the power transmitting segments and the power receiving coils of the electric vehicle as it passes over said one of a plurality of the power transmitting segments.

9. The system according to claim 1, wherein the base stations are configured to calculate a displacement of the receiving coils of a vehicle relative to the power transmitting coils of the one of the pluralities of the power transmitting segments, based on the voltage-to-current phase.

10. The system according to claim 9, wherein the voltage-to-current phase represents one of a plurality of bands, each representing a level of overlap between the power transmitting coils of the one of a plurality of the power transmitting segments and the power receiving coils of the electric vehicle as it passes over said one of a plurality of the power transmitting segments.

11. A method of controlling a frequency of a wireless power signal transmitted from power plurality of power transmitting segments located along a road and under a surface thereof, each power transmitting segment comprising two or more transmitting coils, to power receiving coils located on electric vehicles moving along said road, the method comprising:
selectively powering a plurality of the segments located in series separate wiring via a plurality of base stations located along said road;
converting an alternating current coming from a power grid at a power distribution frequency, and outputting a powering signal at a power transmission frequency range, for each of the segments powered by the base station;
detecting a voltage-to-current phase of the powering signal on one of the segments that has been powered; and
controlling the power transmission frequency of the powering signal on the segment that has been powered, based on the voltage-to-current phase, so as to reduce an absolute value of a voltage-to-current phase to a predefined level as long as the power receiving coils of the electric vehicle are passing over said one of the one of the power transmitting segments that has been powered.

12. The method according to claim 11, wherein the power transmitting segments comprise a communication receiver configured to receive from an authorized electrical vehicle a power request signal, and wherein the converter is switched on only in a case that the power request signal is authorized.

13. The method according to claim 11, wherein the power transmission frequency range is from 80 KHz to 90 Khz.

14. The method according to claim 11, wherein modifying the frequency of the power transmission signal based on the voltage-to-current phase ensures operating at resonance or near-resonance between the power transmitting coils and the power receiving coils throughout the passing of the power receiving coils over the one of the power transmitting segments.

15. The method according to claim 13, wherein the controlling of the power transmission frequency comprises increasing a power level of the powering signal based on the voltage-to-current phase.

16. The method according to claim 11, wherein the controlling of the power transmission frequency comprises modifying the frequency of the power transmitting signal using switching circuitries.

17. The method according to claim 16, wherein the controlling of the power transmission frequency comprises increasing a power level of the powering signal based on the voltage-to-current phase by controlling a duty cycle of said switching circuitry for various bands.

18. The method according to claim 11, wherein the voltage-to-current phase represents one of a plurality of bands, each representing a level of overlap between the power transmitting coils of the one of a plurality of the power transmitting segments and the power receiving coils of the electric vehicle as it passes over said one of a plurality of the power transmitting segments.

19. The method according to claim 11, further comprising calculating a displacement of the receiving coils of a vehicle relative to the power transmitting coils of the one of the pluralities of the power transmitting segments, based on the voltage-to-current phase.

20. The method according to claim 19, wherein the voltage-to-current phase represents one of a plurality of bands, each representing a level of overlap between the power transmitting coils of the one of a plurality of the power transmitting segments and the power receiving coils of the electric vehicle as it passes over said one of a plurality of the power transmitting segments.
